(19) United States
(12) Patent Application Publication
(10) Pub. No.: US 2009/0155742 A1
(43) Pub. Date: Jun. 18, 2009

(54) IMPLANT HAVING MICROGROOVES AND A METHOD FOR PREPARING THE SAME

(75) Inventors: Suk Won Lee, Gyeonggi-do (KR); Namsik Oh, Seoul (KR)

Correspondence Address: LUCAS & MERCANTI, LLP, 475 PARK AVENUE SOUTH, 15TH FLOOR, NEW YORK, NY, 10016, US

(73) Assignee: INHA-INDUSTRY PARTNERSHIP INSTITUTE, Incheon (KR)

(21) Appl. No.: 12/164,605

(22) Filed: Jun. 30, 2008

(30) Foreign Application Priority Data
Dec. 14, 2007 (KR) 10-2007-0130608

(51) Int. Cl. A61C 8/00; A61C 13/00

(52) U.S. Cl. 433/173; 433/201.1; 433/215

(57) ABSTRACT

The present invention relates to a treatment method of the implant abutment surface to increase adhesion between the implant and its surrounding soft tissue, to prevent epithelial down-growth, to prevent bacterial infection, and to extend life-time of the implant and an implant surface-treated by the same. The method for treating surface of the dental implant or implant abutment is characterized by microgroove-formation having greater width and bottom width than the section diameter of a human gingival fibroblast and by additional acid-etching on the whole surface including ridges which used to be left as polished, so that filopodia is actively stretched out to increase adhesion between the implant and its surrounding soft tissues.

### TECHNICAL FIELD

The present invention relates to a dental implant and a method for preparing the same, more precisely, an implant having multiple horizontal microgrooves perpendicular to the long axis having larger width and bottom width than the section diameter of a human gingival fibroblast on the soft tissue attaching area on the surface of the implant and a method for preparing the same.

### BACKGROUND ART

Dental implant or implant for artificial teeth is generally understood as a metal in the shape of a dental root to be planted in jawbone and maintained in the area where a tooth or teeth are lost, so as to form an artificial tooth or teeth. Implant is largely divided as follows: a metal in the shape of a dental root that is implanted in jawbone (the primary operation) and a connected component called abutment that needs prosthodontic treatment after the primary and the secondary operations.

Implant can also be classified according to installation site as follows: subperiosteal implant, endosseous implant, hole type implant, etc. It is also divided by the shape as follows: screw type implant and cylinder type implant. Implant has been widely spread because there is no need of grinding neighboring teeth and alveolar bone is prevented from being resorbed, suggesting that implant is excellent in functional and esthetic aspects.

However, recent studies discovered disadvantages of the conventional implant such as unstable attachment of soft tissue onto implant abutment, inevitable epithelial down-growth, high chance of pathogen invasion through the crevice between adhesion sites, and resultingly possible gingival inflammation around implant and reduction of implant life-time.

To overcome the above problems, it has been requested to develop a novel implant having enough stability and high attachment force between implant and bone as well as between implant abutment and soft tissue so as to secure the installed dental implant. Metals used for dental implant such as titanium, zirconium, hafnium, tantalum, niobium or some of their alloys have comparatively strong attachment to osseous tissue, which could be as strong as or stronger than that of osseous tissue itself. The most expecting metal for dental implant is titanium or titanium alloy, and in fact, studies on the attachment of osseous tissues onto metal have been carried out since 1950s, and as a result “osseointegration” has been established.

Although attachment of osseous tissue onto implant was strong and particularly, attachment of osseous tissue onto titanium was comparatively strong, the attachment still needs to be improved. To do so, various attempts have been made.

Up to date, a method has been developed to increase surface roughness with irregularity in order to improve implant-bone attachment. The increased surface roughness brings stronger contact between implant and osseous tissue and larger fixed area, resulting in increased mechanical arrest and strength.

Since the idea of osseointegration was established, interests of scientists have been focused on the improvement of interaction between implant and surrounding soft tissue, that is, peri-implant soft tissue reaction.

Brunette et al. (Brunette et al., J. Biomech. Eng. 121:49-57, 1999) and Jansen et al. (Jansen et al., Adv. Dent. Res. 13:57-66, 1999) have carried on their studies introducing that gingival fibroblasts, the most representative cells forming soft tissue around the dental implant, change cell morphology and cell-substratum adhesion on microtopography. The improvement of cell-substratum adhesion between the titanium implant and cell aims at minimizing or preventing epithelial down-growth, understood as an aftereffect of implantation. The above research groups emphasized that the surface of microfabricated groove could induce epithelial orientation and directed locomotion in vitro, and thus it could prevent epithelial down-growth around the titanium dental implant in vivo. Based on the idea that the surface topography of the titanium dental implant is an important element for forming connective tissue, cell morphology and orientation of fibroblasts have been examined by different approaches. As a result, it was verified that the effect of surface topography of titanium substrata having microgrooves on cell behavior in vivo and in vitro is determined by the dimension of the microgroove.

Microgrooves used by those researchers including Brunette et al. and Jansen et al. are V-shaped microgrooves constructed by micromachining technique which favors edge adhesion of cells (FIG. 1 and FIG. 2). Cells adhered to the microgrooved substratum are allowed to spread to only two directions. First, spreading in parallel with groove/ridge is elongation or polarization, which is attributed to contact guidance (Weiss, P. J. Exp. Zool. 100: 353-86, 1945) Another example is bridging between ridges. Based on the geometry, cells strengthen focal contact (den Braber, E. T. et al., Biomater. 17: 2037-44, 1996) and increase cellular traction force (Wang, N. et al., Cell Motil. Cytoskeleton 52: 97-106, 2002) transmitted to the focal contact, and accordingly increase the number of focal contacts (Chen, C. S. et al., Blochem. Biophys. Res. Commun. 307: 355-61, 2003, FIG. 3). The increased adhesion strength thereby has been shown to be greater than local mechanical force (Loesberg, W. A. et al., J. Biomed. Mater. Res. A 75: 723-32, 2005; Loesberg, W. A. et al, Cell Motil. Cytoskeleton 63: 384-94, 2006). ‘Contractile traction force exerted by a cell’, which is also called as cytoskeletal tension per se or cytoskeletal prestress, is known to play a crucial role in the regulation of various biological activities including gene expression and growth, by using focal contact as an anchorage, along with extracellular matrix (ECM) and cytoskeletal structure (Ingber, D. E. et al., J. Cell Sci. 116: 1397-1408, 2003). Surface structure changes gene expression frequency by inducing direct cell mechanotransduction (Dalby, M. J. et al., Med. Eng. Phys. 27: 730-41, 2005). In the biomechanical models, micropattern or nanostructured surface has been artificially applied to cells in order to induce changes in cell shape and cell spreading. The most representative example is that cell adhesion to sharp edge of microstructure is strengthened and thus ‘contractile traction force exerted by a cell’ increases in a specific direction (Thery, M. et at., Cell Motil. Cytoskeleton 63: 341-55, 2006).

The next example of application of the microgrooves on implant surface is that microgrooves are adhered on dental implant's abutment surface by using laser. Microgrooves are adhered on both osseous tissue and soft tissue contacting areas but the widths are different. However, a preferable width is not determined, yet, and still under investigation. In particular, grooves in the widths of several microns which are applied on the implant abutment surface are actually in smaller sizes than the diameter of natural section of gingival fibroblasts forming gingival connective tissue.

A number of previous studies reported that cell morphology was changed by microgrooves, which was closely related to gene expression and cell growth in adherent cells (Folkman, J. et al., Nature 273: 345-49, 1978). Human gingival fibroblasts cultured on microgrooved substrata showed significantly increased contact including elongation and orientation along the grooves, known as contact guidance, compared with the cells cultured on smooth substrata a result, the amount of fibronectin mRNA in each cell was increased (Chou, L. et al., J. Cell Sci. 108: 1563-73, 1995) and expressions of genes involved in various biological functions were changed (Dalby, M. J. et al., Exp. Cell Res. 284: 274-82, 2003). In those studies, microgrooved substrata having the microgrooves with widths of several microns, which is narrower than the diameter of a single cell, was used. Up to date, only a few studies showed comparison of fibroblast growths on different sized microgrooved substrata. Most of such in vivo studies used subtrata provided with grooves having comparatively narrow spacing or width of 1-10 μm, from which contact guidance was pretty successful but proliferating activity of adhered fibroblasts was not clearly verified (den Braber, E. T. et al., Biomater. 17: 1093-99, 1996; Walboomers, X. F. et al., J. Biomed. Mater. Res. 47: 204-12, 1999; Walboomers, X. F. et al., J. Biomed. Mater. Res. 46: 212-20, 1999). Results of in vitro studies for preventing or reducing epithelial down-growth by using microgrooved implant abutments were different between those from Brunette et al. and Jansen et al. Two significant differences in experimental designs of their studies are found in flexibility of implant material and structural dimension of the provided microgrooves, which suggests that the size of microgrooves is a crucial factor affecting the result of in vivo studies.

In conclusion, microgrooves having narrower spacing than the diameter of an adherent fibroblast have been verified to change cell morphology and accordingly to induce change of gene expression and to increase focal adhesion. But, the presumed effect of promotion of cell proliferation in vitro or reduction of epithelial down-growth in vivo was not verified, yet.

### DISCLOSURE

### Technical Problem

It is an object of the present invention to provide a dental implant or implant abutment having strengthened adhesion on soft tissue, preventing epithelial down-growth and bacterial infection, and having increased life-time.

It is another object of the present invention to provide a method for preparing the dental implant or implant abutment.

### Technical Solution

Terminology

photolithography: the process of transcription of geometrical pattern on the surface of a semiconductor substrate according to the shape of a mask.

photo-resist: photosensitive resin which is generally composed of polymer, solvent and/or sensitizer. It is classified into a positive photo-resist and a negative photo-resist according to the developing shape. Particularly, the positive photo-resist excludes irradiated region, while the negative photo-resist includes only the irradiated region. The positive photo-resist includes polymetylmethaneacrylate (PMMA), DQN (diazoquinone), Novolak substrate resin resist, etc. PMMA, for example, is functioning as photo-resist only with its single component resin. DQN is a kind of diazoquinone sensitizer, and Novolak substrate resin is a polymer. The negative photo-resist is exemplified by bis(aryl)azide rubber resin.

acid-etching: the process of corrosion of the non-protected region of the surface of a solid substrate such as glass, semiconductor, metal, etc, by using acid.

### DETAILED DESCRIPTION

To achieve the above objects, the present invention provides a dental implant characteristically having microgrooves in the shape of well on adherent region of the implant surface, which is composed of an abutment region in the upper part where an artificial tooth is fixed and a dental implant region in the lower part which is installed on jawbone.

The section of the microgroove in the shape of a well preferably has the shape of a rectangle or a trapezoid, but not always limited thereto. The width and the bottom width of the section are preferably greater than the section diameter of a human gingival fibroblast, but not always limited thereto. The width and the bottom width of the microgroove are preferably 10-90 μm, more preferably 15-70 μm. The depth of the microgroove is preferably 3-15 μm and more preferably 3.5-10 μm. Further, the microgroove is preferably applied on the surface of abutment of the dental implant and an additional acid-etching can be induced on the surface of the abutment. At this time, the implant is preferably titanium, titanium alloy or ceramic, but not always limited thereto and the acid usable for etching is exemplified by hydrofluoric acid (HF), acetic acid, fuming sulfuric acid, fuming nitric acid, hydrochloric acid (HCl) or a mixture thereof, but not always limited thereto and any acid capable of eroding the implant can be used.

The present invention also provides a method for preparing a dental implant using photolithography.

The method for preparing a dental implant of the present invention comprises the following steps:

i) treating photo-resist onto the surface of abutment of a dental implant except the region reserved for forming grooves;

ii) performing acid-etching on the implant treated with the photo-resist in step 1); and

iii) eliminating the photo-resist from the implant finished with acid-etching.

Herein, the section of the groove preferably has the shape of a rectangle or a trapezoid, but not always limited thereto. The width and the bottom width of the groove are preferably greater than the section diameter of a gingival fibroblast, but not always limited thereto. The photo-resist herein can be either a positive photo-resist or a negative photo-resist, but a positive photo-resist is preferred considering acid-resistance. The photo-resist is exemplified by polymetylmethaneacrylate (PMMA) or bisarylazide Novolak (BQN) photo-resist, but not always limited thereto and any photo-resist known to those in the art can be used. The negative photo-resist can be bis(aryl)azide rubber resin, but not always limited thereto and any negative photo-resist known to those in the art can be used. The implant is preferably titanium, titanium alloy or ceramic, but not always limited thereto and the acid usable for etching is exemplified by HF, acetic acid, fuming sulfuric acid, fuming nitric acid, HCl or a mixture thereof, but not always limited thereto and any acid capable of eroding the implant can be used.

The method for preparing a dental implant of the present invention can additionally include the step of acid-etching on the surface of the dental implant or implant abutment after elimination of photo-resist. If acid-etching is performed on the entire surface area of the dental implant or implant abutment, the surface area of the implant will be increased, resulting in the increase of cell adhesion, spreading, growth, proliferation and gene expression.

The present invention brings the said effect by forming microgrooves having greater width and bottom width than the section diameter of a human gingival fibroblast on the surface of the dental implant or implant abutment. The microgroove of the present invention has the shape of well, unlike the conventional microgroove having the shave of V, so that a separate groove/ridge floor is generated for cell adhesion. Owing to the larger and flatter groove floor and ridge than the section diameter of a human gingival fibroblast, the human gingival fibroblast proliferation is improved over the groove and ridge, compared with that by the conventional microgroove.

To form the groove in the shape of well, the present inventors applied photolithography used for the production of a semiconductor on the surface of the groove.

The present inventors treated photo-resist to the surface of a dental implant except the region reserved for groove-formation, followed by acid-etching using HF to form grooves. The present inventors eliminated the photo-resist after forming grooves by the said method to complete the microgrooved titanium implant or implant abutment.

To prove that the implant having microgrooves in the shape of well of the present invention could strengthen the adhesion of surrounding soft tissue to the dental implant or implant abutment, the inventors constructed titanium substrata with microgrooves in different width, bottom width and depth, by using photolithography and used for the experimental groups A flat and smooth titanium substratum was used for the control (smooth Ti). Human gingival fibroblasts were cultured on each substratum over different times. The human gingival fibroblasts of experimental groups classified by presence and size of microgrooves were examined for general cell behaviors including cell-substratum adhesion, cell morphology, cell proliferation and growth and gene expression.

First, to measure the cell proliferation of the human gingival fibroblasts, XTT (2,3-bis[2-methyloxy-4-nitro-5-sulfophenyl]-2H-tetrazolium-5-carboxanilide) assay was performed. As a result, it was demonstrated that the human gingival fibroblasts cultured on the titanium substrata on which microgrooves having greater widths and bottom widths than the section diameter of a human gingival fibroblast were formed exhibited improved cell (FIG. 4).

To demonstrate whether the microgrooves in the shape of well formed on the surface of the implant could increase the expression of a matrix producing gene, fibronectin and a5 integrin mRNA expressions in human gingival fibroblasts cultured on the titanium substrata with microgrooves were investigated. As a result, higher expressions of both genes of the cells cultured on the titanium substrate with microgrooves were obvious compared with those of the cells cultured on the smooth Ti substrata In particular, when the width and bottom width of the microgrooves was greater than the diameter of the human gingival fibroblast, the expression levels were much higher (FIG. 5).

The present inventors presumed the reason of the above results as that when human gingival fibroblasts were adhered to and proliferated even on the floor of the microgrooves (FIG. 6), the cells recognized the environment surrounding them, that is 15-30 μm width caused by microgrooves, as the third dimension and thus induced expression of the genes corresponding to the environment, resulting in the changes in general cell behavior. The cell behavior herein includes most of cell activities determining characteristics and fate of cells such as cell-substratum adhesion, cell proliferation, cell morphology and orientation, and gene expression.

During the experiments, the present inventors found out that cells generated and stretched out filopodia actively on the finished acid-etched surface of the side wall and floor of microgrooves formed by photolithography. The filopodia is a cell organelle responsible for cell adhesion and migration. Based on the above finding, the present inventors established a theory that cell behavior could be significantly changed by the additional acid-etching on the whole titanium surface after the first acid-etching (photolithography) to form microgrooves, and continued the studies based on that.

The present inventors diversified width, bottom width and depth of microgrooves formed by photolithography, compared with those of conventional microgrooves and performed additional acid-etching on the entire surface of the microgrooved titanium substrata, that is not only the surface of inside of the grooves but also the surface of ridges, followed by investigation on cell-substratum adhesion and cell proliferation on the implant having significantly increased micro-surface area. As a result, it was verified that the cells cultured on the microgrooved titanium implants treated with additional acid-etching on the entire surface exhibited significantly increased cell-substratum adhesion and cell proliferation compared with the smooth surface implant.

In addition, the present inventors diversified width, bottom width and depth of microgrooves and selected the widths and depths of the experimental groups to be in proportion, that is, the microgrooves were designed to be from narrower and shallower to wider and deeper and also divided the experimental groups according to the presence/absence of additional acid-etching, followed by comparing cell proliferation and gene expressions in those groups. As a result, cell proliferation and the related gene expressions on the titanium substrata having microgrooves having comparatively greater width, bottom width and depth and treated with additional acid-etching were remarkably increased.

Based on the above results of three different experiments, the present inventors confirmed that the surface of the titanium implant with microgrooves having comparatively greater width, bottom width and depth and treated with additional acid-etching changed cell behavior of human gingival fibroblasts more preferably than the smooth surface of the conventional implant.

### Advantageous Effect

The microgrooves in the shape of well having greater width and bottom width than the section diameter of a human gingival fibroblast were improved From the conventional V-shaped grooves not having separate groove/ridge floor area on which cells are adhered (FIG. 1). V-shape allows cell-substratum adhesion only at sharp edges, so that extreme cell spreading is induced at the edge (FIG. 2), which is a huge difference from the present invention characteristically inducing cell morphology similar to that in a three-dimensional cell culture model.

Another effect of the present invention is to induce changes in cell morphology as close to the morphology of in viva fibroblasts as possible. Unlike the grooves having V-shape, the design of the present invention enables improvement of cell-substratum adhesion and cell proliferation at the same time by treating an additional acid-etching on the entire titanium surface after forming microgrooves thereon, which was a novel discovery by the present inventors.

It was once reported that cell growth of osteoblasts was increased by increasing artificially the roughness or irregularity of the surface of a titanium dental implant by acid-etching and blasting. But, the titanium substrata for cell culture and the dental implant model having microgrooves or microgrooves/acid-etching together have not been reported, yet. The present inventors are the first to prove the effect of the above implant with experiments and established the method of preparing the same.

The dental implant of the present invention is characterized by grooves and ridges at micro-level and the surface roughness at nano-level. Therefore, the dental implant of the present invention is effective in fibroblast proliferation, which has been proved as a scientific fact. Based on that, implant adhesion onto soft tissue is strengthened and side-effects during implant-soft tissue attachment can be significantly reduced, and further life-time of the implant can be extended.

### DESCRIPTION OF DRAWINGS

The application of the preferred embodiments of the present invention is best understood with reference to the accompanying drawings, wherein:

FIG. 1 is a diagram illustrating the V-shaped. microgrooves of Brunette group and Jansen group.

FIG. 2 is a SEM photograph of fibroblasts cultured on the titanium substratum with V-shaped microgrooves prepared by the method of Jansen group.

FIG. 3 is a diagram illustrating the fabrication process of the microgrooved titanium substrata using photolithography:

photo-resist: photo-resist,

Ti disc: titanium disc,

HF etching: hydrofluoric acid etching,

photo-resist removing: elimination of photo-resist,

ridge width: width of a ridge,

groove width: width of a groove,

bottom width: width of the bottom of a groove,

groove depth: depth of a groove.

FIG. 4 is a graph illustrating the cell proliferation of human gingival fibroblasts analyzed by XTT assay.

FIG. 5 is a photograph illustrating the mRNA expression patterns of matrix assembly genes according to the treatment of microgrooves.

FIG. 6 is a scanning electron microscopic (SEM) image of human gingival fibroblasts according to the treatment of microgrooves having 30/3.5 μm width/depth of the present invention.

FIG. 7 is a SEM photograph of the acid-etching surfaces of side walls and floor area of grooves after microgroove formation by photolithography.

FIG. 8 is a SEM photograph illustrating the surface of the titanium substrata with microgrooves additionally treated with acid-etching on the entire surfaces including grooves and ridges of the titanium substrata.

FIG. 9 and FIG. 10 are graphs illustrating the results of adhesion analysis and proliferation assay of experimental groups treated with additional acid-etching on the entire surface including grooves and ridges of the titanium substrate.

FIG. 11 and FIG. 12 are graphs illustrating the results of BrdU assay comparing cell proliferation of different experimental groups having different width, bottom width and depth of microgrooves and treated or not-treated with acid-etching.

FIG. 13 is a photograph illustrating the expression patterns of genes involved in cell-substratum adhesion and cell proliferation of different experimental groups having different width, bottom width and depth of microgrooves and the presence/absence of additional acid-etching.

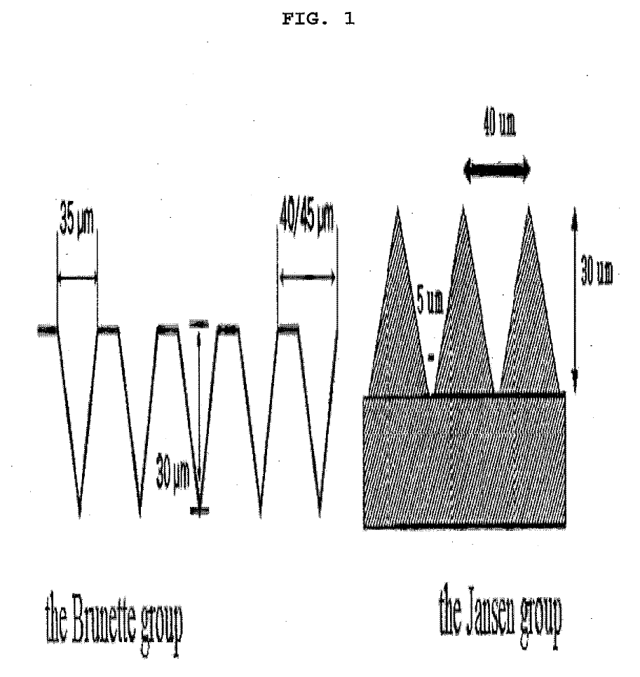

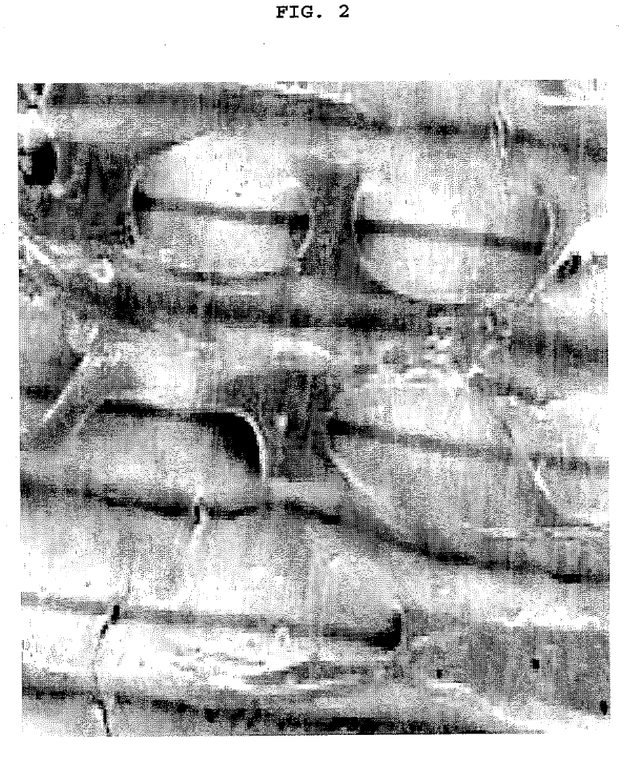

### MODE FOR INVENTION

Practical and presently preferred embodiments of the present invention are illustrative as shown in the following Examples.

However, it will be appreciated that those skilled in the art, on consideration of this disclosure, may make modifications and improvements within the spirit and scope of the present invention.

### EXAMPLE 1-EXAMPLE 3

### Construction of Titanium Substrata with Microgrooves in the Shape of Well

To generate microgrooves in the shape of well, the present inventors used photolithography.

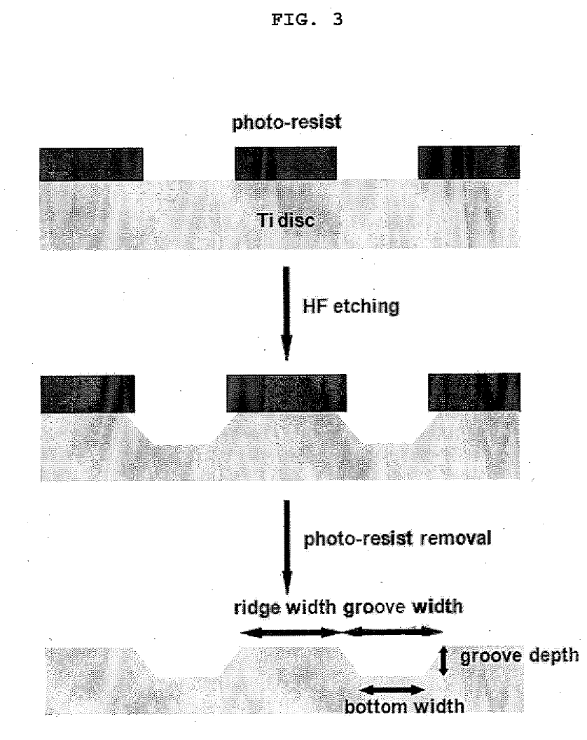

As shown in FIG. 3, the pure titanium surface was treated with photo-resist except the region reserved for groove formation, followed by HF-etching to form grooves. After generating grooves, the photo-resist was eliminated, resulting in the titanium implant with microgrooves.

The constructed titanium substrates were 15/3.5 μm, 30/3.5 μm, 60/3.5 μm in spacing/depth respectively {TiD15 (Example 1), TiD30 (Example 2), and TiD60 (Example 3)}.

### EXAMPLE 4-EXAMPLE 10

### Construction of Titanium Substrates with Microgrooves Having Different Width, Bottom Width and Depth and Treated with Additional Acid-Etching

To investigate the influence of width, bottom width and depth of the microgrooves formed on the titanium substrata on cell-substratum adhesion and cell proliferation, the present inventors, as shown in the below Table 1, constructed titanium substrata having different depths of microgrooves from those prepared in Examples 1-3. At this time, according to homoscedastic principle of photolithography, bottom width of the groove was calculated by width−2*depth. The entire surface area including ridges and grooves was treated with additional acid-etching to diversify width, bottom width and depth of microgrooves. As a result, titanium substrates treated with the additional acid-etching were prepared.

TABLE 1
Titanium substrates with microgrooves having different
width, bottom width and depth and treated with additional
acid-etching (Examples 4-10)

| | | | | Bottom | |
|---|---|---|---|---|---|
| | | Width | Depth | width | |
| Example | Substrate | (μm) | (μm) | (μm) | Acid-etching |
| 4 | Smooth Ti | 0 | 0 | 0 | non-etched |
| 5 | E0 | 0 | 0 | 0 | acid-etched |
| 6 | E15/3.5 | 15 | 3.5 | 8 | acid-etched |
| 7 | E30/5 | 30 | 5 | 20 | acid-etched |
| 8 | E30/10 | 30 | 10 | 10 | acid-etched |
| 9 | E60/5 | 60 | 5 | 50 | acid-etched |
| 10 | E60/10 | 60 | 10 | 40 | acid-etched |

Width: width of a groove,
Depth: depth of a groove,
Bottom width: width of the bottom of a groove

### EXAMPLE 11-EXAMPLE 19

### Fabrication of Titanium Substrata with Microgrooves Having Different Width, Bottom Width and Depth and the Presence/Absence of Additional Acid-Etching

The present inventors fabricated more experimental groups of substrata having microgrooves with 5-90 μm in width based on the titanium substrata prepared in Examples 1-3. Those experimental groups were divided by the depth, that is different experimental groups were prepared by increasing width and increasing depth thereby. Experimental groups were also differently treated in acid-etching, that is, some of them were treated with acid-etching and others were not. The groups not-treated with acid-etching includes smooth titanium surface group and those groups demonstrating significant difference from those smooth titanium surface groups used in Examples 1-3.

TABLE 2
Titanium substrates with microgrooves having different
depth, width and spacing and treated with additional acid-
etching (Examples 11-19)

| | | | | Bottom | |
|---|---|---|---|---|---|
| | | Width | Depth | width | |
| Example | Substrate | (μm) | (μm) | (μm) | Acid-etching |
| 11 | E0 | 0 | 0 | 0 | acid-etched |
| 12 | E5/1 | 5 | 1 | 3 | acid-etched |
| 13 | E15/3.5 | 15 | 3.5 | 8 | acid-etched |
| 14 | E30/5 | 30 | 5 | 20 | acid-etched |
| 15 | E60/10 | 60 | 10 | 40 | acid-etched |
| 16 | E90/15 | 90 | 15 | 60 | acid-etched |
| 17 | NE0 | 0 | 0 | 0 | acid-etched |
| 18 | NE15/3.5 | 15 | 3.5 | 8 | acid-etched |
| 19 | NE30/5 | 30 | 10 | 10 | acid-etched |

Width: width of a groove,
Depth: depth of a groove,
Bottom width: width of the bottom of a groove

### EXPERIMENTAL EXAMPLE 1

### Effect of the Presence of Microgrooves of the Implant Surface and Their Dimensions on Cell Proliferation and Expressions of Matrix Assembly Genes

### <1-1> Analysis on Cell Proliferation

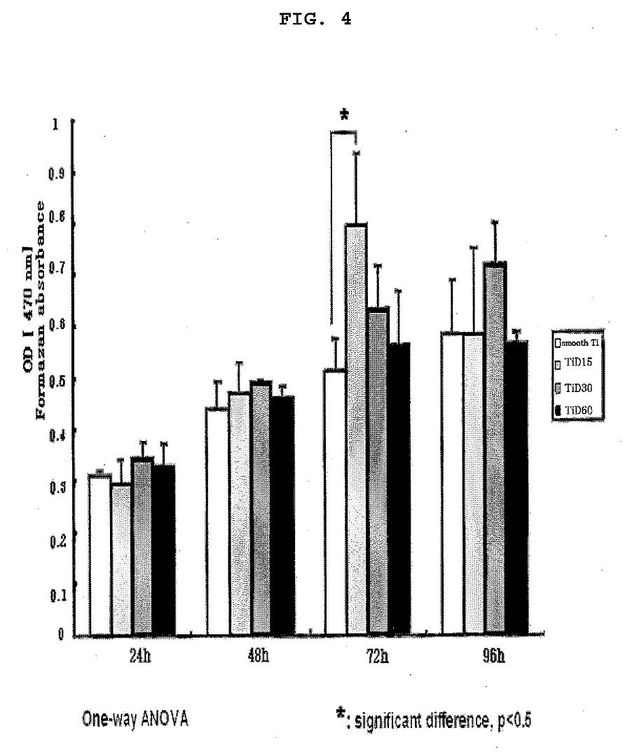

The present inventors used the titanium substrates with microgrooves prepared in Examples 1-3 by using photolithography as experimental groups (TiD15, TiD30 and TiD60) and the smooth titanium substrata as a control (smooth Ti). Human gingival fibroblasts were cultured on the surface of each substratum for 24, 48, 72 and 96 hours respectively, and then cell proliferation was analyzed considering the presence or absence of microgrooves and their dimensions (width). Particularly, XTT assay was performed to investigate cell proliferation of the human gingival fibroblasts in each group. The XTT assay was performed according to the method of Scudiero et al (Scudiero et al., Cancer Res., 48(17): 4827-4833, 1988) by using XTT assay kit (Cell Proliferation Kit II, Roche Applied Science, Germany) As shown in FIG. 4, when microgrooves having 15/3.5 μm (width/depth, TiD15) were formed on the titanium substratum surface, cell proliferation of the human gingival fibroblasts cultured thereon was significantly increased.

In addition, when microgrooves having 30/3.5 μm (width/depth, TiD30) were formed, cell proliferation was gradually increased regardless of different culture time.

### <1-2>Analysis on Gene Expression

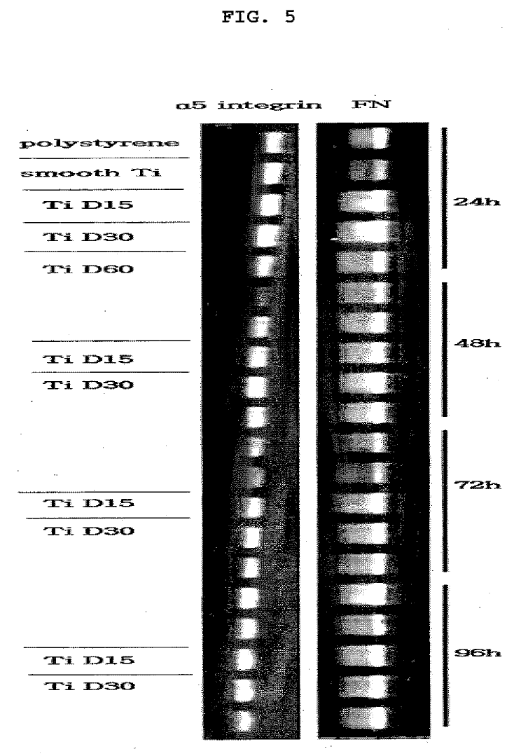

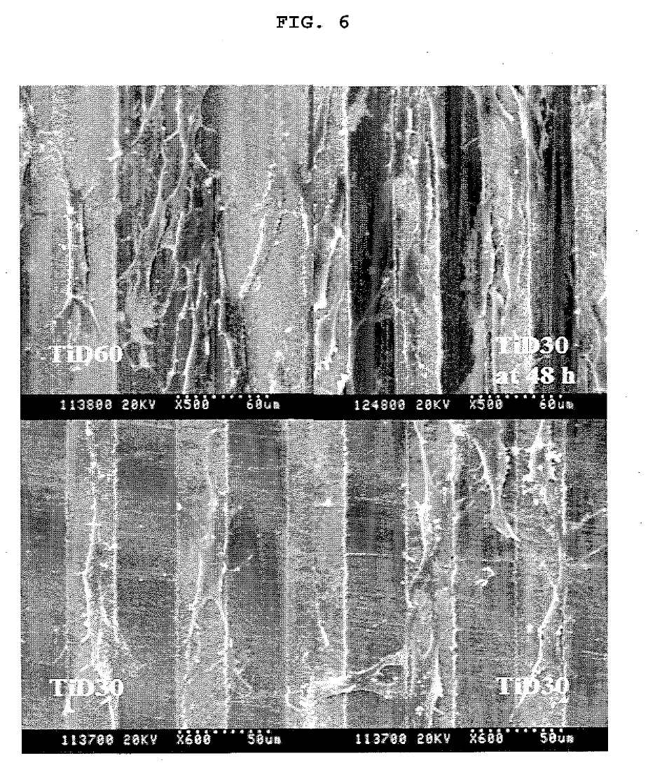

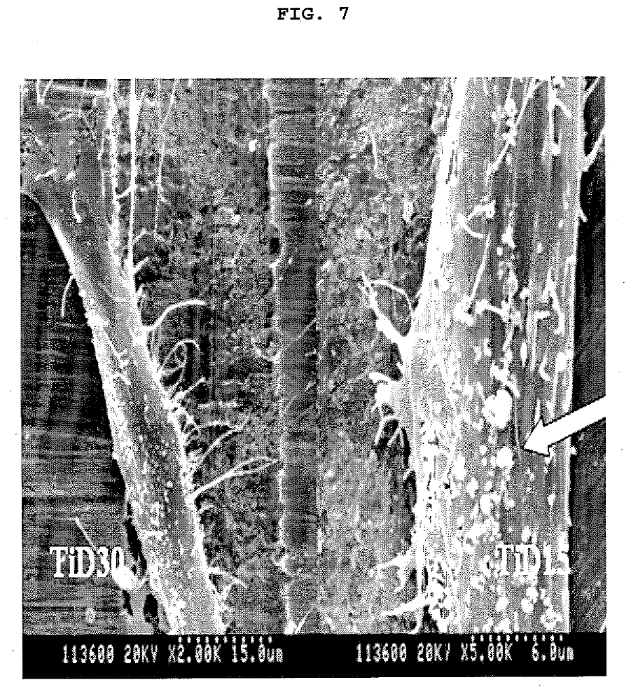

The present inventors investigated the expressions of matrix assembly genes encoding substrate proteins necessary for cell-substratum adhesion and cell proliferation. Particularly, RT-PCR (reverse transcriptase-polymerase chain reaction) was performed to investigate the expressions of fibronectin (FN) and a5-integrin mRNAs (two most representative matrix assembly genes) of human gingival fibroblasts cultured on the smooth titanium substratum and the microgrooved titanium substratum of the present invention (Examples 1-3). The cultured cells were obtained by treating trypsin. Total RNA was extracted from the cells by using RNA extraction kit (Trizol, Gibco BRL, USA) according to the manufacturer's instruction. The cells cultured on the bottom of a 24-well polystyrene microplate were used as the positive control. OD₂₆₀ of the total RNA extracted from each sample was measured to calculate the concentration. 1 mg of the total RNA extracted from each sample was converted into cDNA by using reverse transcriptase (Promega, USA). PCR was performed using Taq DNA polymerase (Roche Diagnostics, Germany), 10× buffer, 25 mM MgCl₂ and 25 mM dNTP (dGTP, dCTP, DATP and dTTP). Amplification was performed in PCR thermal cycler (Bio-Rad Laboratories, Inc., USA) as follows: at 94° C. for 30 seconds, at 58° C. for 45 seconds and at 72° C. for 30 seconds (35 cycles). The PCR product was electrophoresed on 2% agarose gel, followed by staining with ethidium bromide for observation (FIG. 5). At this time, FN forward primer represented by SEQ. ID. NO: 1 (5′-CGAACATCCACACGGTAG-3′) and FN reverse primer represented by SEQ. ID. NO: 2 (5′-ATCACATCCACACGGTAG-3′) were used for the amplification of fibronectin gene. And a5 integrin forward primer represented by SEQ. ID. NO: 3 (5′-ACCAAGGCCCCAGCTCCATTAG-3′) and a5 reverse primer represented by SEQ. ID. NO: 4 (5′-GCCTCACACTGCAGGCTAAATG-3′) were used for the amplification of a5 integrin. As a result, as shown in FIG. 5, the microgrooved titanium substrata prepared by forming microgrooves having 15/3.5 μm of width/depth (TiD15) and 30/3.5 μm of width/depth (TiD30) on the surface by using photolithography, which were the titanium implants having microgrooves in the shape of well, demonstrated significantly increased expressions of matrix assembly genes of human gingival fibroblasts, compared with the conventional smooth titanium substratum. The present inventors presented the reasons of the above results in FIG. 6 by examining cell morphology: i) Human gingival fibroblasts adhered to grow on every surface of microgrooves including floors and ridges having 15/3.5 μm (TiD15) of width/depth and 30/3.5 μm (TiD30) of width/depth were verified to proliferate longer; and ii) In relation to the increase of expressions of FN and a5-integrin genes, the microgrooves provided 3-dimensional cell culture environment for the human gingival fibroblasts to induce corresponding cell morphology, orientation and gene expression. During this exemplary experiment, the present inventors found out a very interesting fact that fibroblasts extruded filopodia vigorously onto the surface of acid-etched area necessarily formed on the side wall and floor of microgrooves formed by photolithography, as shown in FIG. 7.

The present inventors predicted that the additional acid-etching on the whole surface of the titanium substratum after the first acid-etching (photolithography) to form microgrooves could make different cell proliferation assay result from that of Experimental Example 1 (FIG. 4) and further examine more accurately the result of Experimental Example 1. In Experimental Example 1, cell proliferation inducing effect of microgrooves was not fully confirmed. However, it was expected that continuing studies could explain the effect.

### EXPERIMENTAL EXAMPLE 2

### Analysis on Cell-Substratum Adhesion and Proliferation After the Additional Acid-Etching After Forming Microgrooves on the Surface of a Dental Implant

Based on the previous finding that human gingival fibroblasts protrude filopodia widely on the floor of microgrooves formed by acid-etching (photolithography) on the surface of the implant and the filopodia is the cell organelle involved in adhesion and migration of cells, the present inventors investigated cell behaviors of those adhered cells after treating the implant with acid-etching additionally.

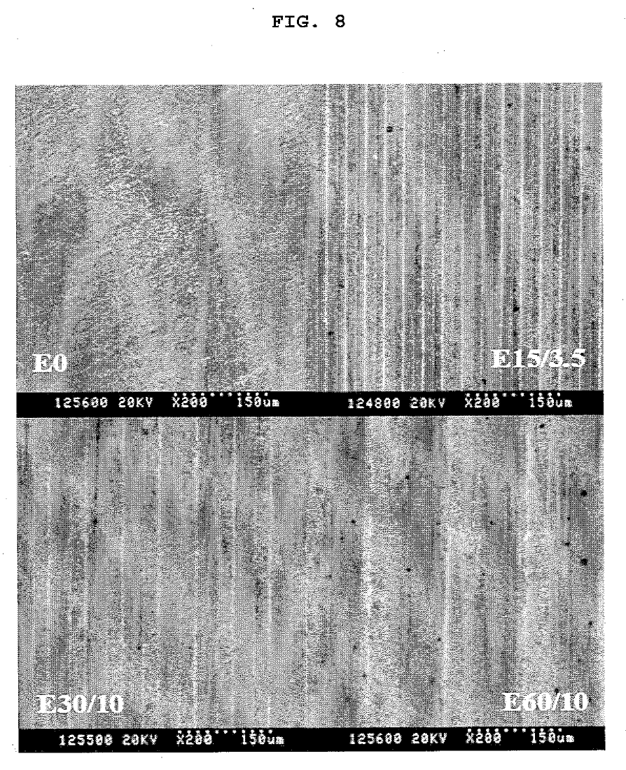

Particularly, depths of the microgrooves of experimental groups were controlled to 3.5 μm, 5 μm and 10 μm, to which additional acid-etching was performed (FIG. 8). Polystyrene tissue culture plastic surface and smooth surface were considered as controls. The surface not having microgrooves but treated with acid-etching was included in experimental groups. Then, different microgrooved-acid-etching complex surfaces were prepared and compared. That is, surfaces having or not having microgrooves and treated or not treated with acid-etching were prepared as study models (Table 1, Examples 4-10).

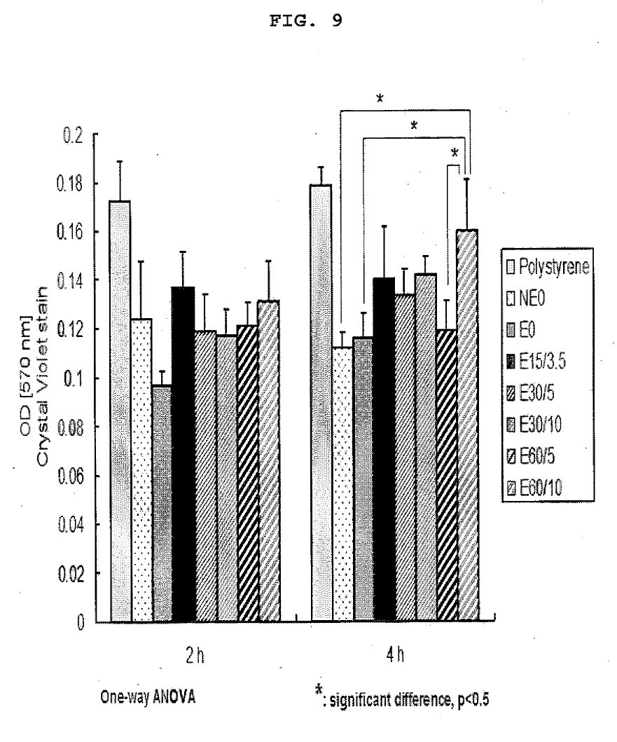

For the analysis of cell-substratum adhesion, crystal violet staining was performed. 2 and 4 hours after the cell inoculation, cell-substratum adhesion was investigated. As a result, cell-substratum adhesion was significantly increased in the experimental group (Example 10) having comparatively greater width, bottom width and depth of microgrooves and treated with additional acid etching, compared with the smooth titanium substratum (Example 4) and the titanium substratum (Example 5) treated with acid-etching without microgrooves generated (FIG. 9).

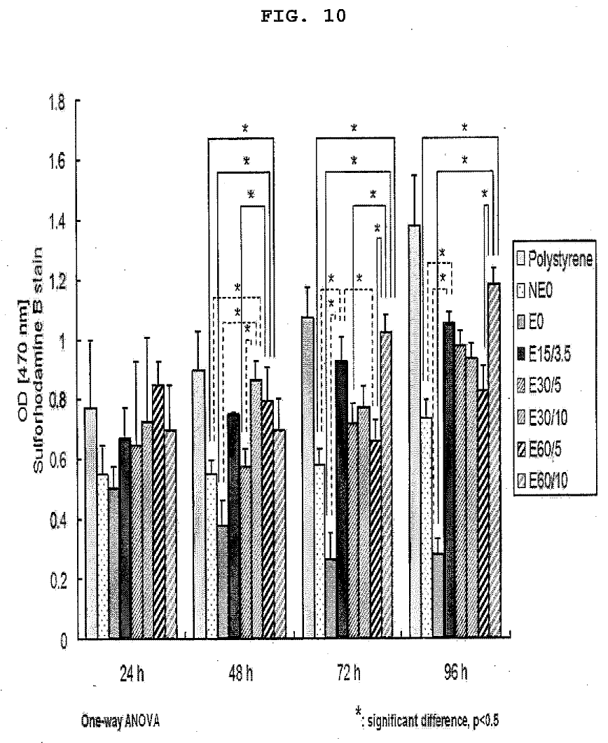

Sulforhodamine B (SRB) analysis was performed according to the method of O'Connell et al. Particularly, sulforohdamine B staining was performed to analyze cell proliferation. Cell growth over the culture times of 24, 48, 72 and 96 hours was investigated (O'Connell et al., Clin. Chem. 31(9):1424-1426, 1985). As a result, almost every experimental group except the experimental groups (Example 7 and Example 9) having shallow depth of microgrooves, compared with width, demonstrated significantly increased cell proliferation, compared with the group (Example 5) treated with acid-etching without generating microgrooves (FIG. 10).

From the above results, it was confirmed that the titanium implant having greater width, bottom width and depth of microgrooves and treated with additional acid-etching could significantly increase cell-substratum adhesion and cell growth of human gingival fibroblasts. It was interesting that the experimental group (Example 5) only treated with acid-etching without forming microgrooves demonstrated lower cell proliferation activity than the smooth substrata (control, Example 4), suggesting that acid-etching alone could not preferably change cell-substrate adhesion and cell proliferation and microgroove formation has to be accompanied.

### EXPERIMENTAL EXAMPLE 3

### Cell Proliferation and Gene Expression According to Microgroove Formation on the Implant Surface and the Additional Acid-Etching

### <3-1> Cell Proliferation Analysis

The present inventors designed experimental models by diversifying width and depth of microgrooves in addition to the models established in Experimental Examples 1 and 2. Then, cell proliferation and gene expression on the implants on which microgrooves were formed and acid-etching was performed (Examples 11-19, Table 2) were investigated to examine nano-micro complex surface pattern that might be a favorable factor for cell behavior.

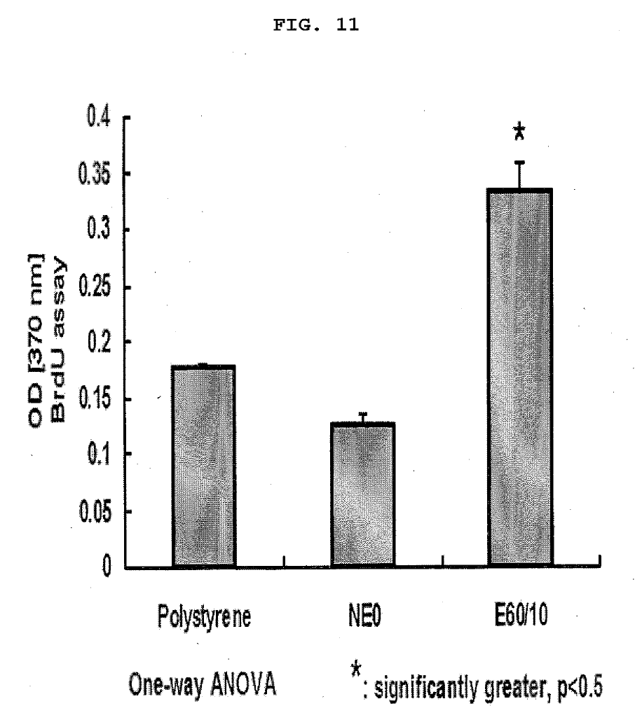

As a pre-experiment, BrdU assay was performed to compare cell proliferations between the experimental groups (Example 15) presumed to have a huge effect and the controls (polystyrene and FIG. 11). Particularly, BrdU assay was performed using BrdU incorporation kit (cell proliferation ELISA system, Roche, USA) according to the manufacturer's instruction. BrdU assay is a method to measure cell growth in relation to DNA production, which was not used in Experimental Examples 1 and 2 It was also expected by performing BrdU assay to confirm the result of cell proliferation analysis. As a result, it was confirmed that the titanium implant with microgrooves having larger width and depth and treated with additional acid-etching was effective in promoting cell proliferation, compared with the implant having smooth surface.

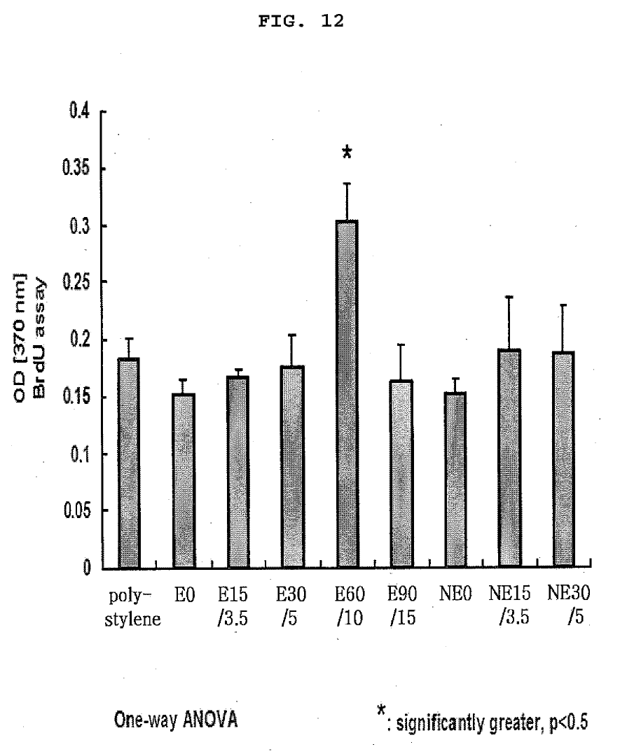

Based on the above result, as described in Examples 11-19, as shown in Table 2, different titanium substrata having microgrooves and treated or not treated with additional acid-etching were prepared, followed by cell proliferation analysis using BrdU assay (FIG. 12). As a result, it was confirmed that the titanium implant (Example 15) with microgrooves having comparatively larger surface and greater width and depth and treated with additional acid-etching was much effective in improving cell proliferation. It was interesting though that the implant (Example 16) with microgrooves having too big width and depth was not much effective in improving cell proliferation.

### <3-2> Analysis on Gene Expression

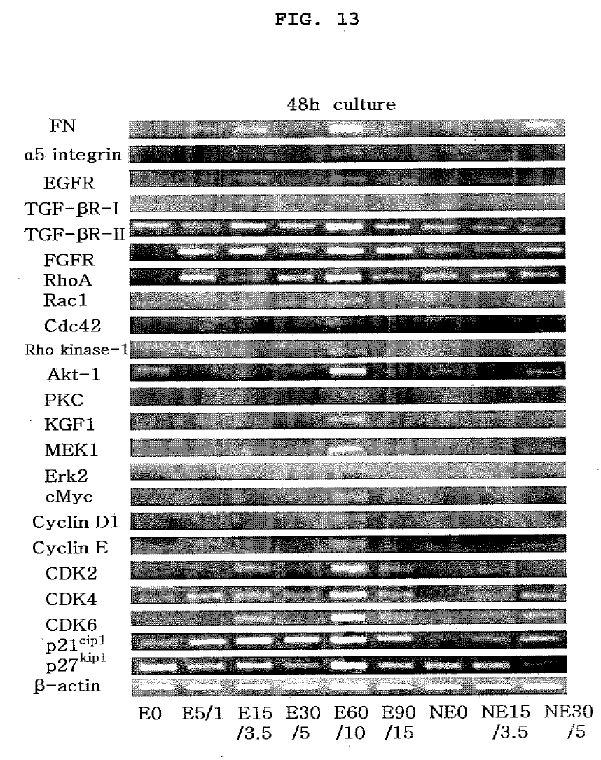

The present inventors investigated the expressions of 23 genes known to be involved in cell-substratum adhesion and cell proliferation of the cells cultured for 48 hours on the substrata of experimental groups (Examples 11-19) (Table 3 and FIG. 13). Experiments were performed by the same manner as described in Experimental Examples 1-2, and as a house-keeping gene, beta-actin gene was used. As a result, the titanium implant (Example 15) with microgrooves having comparatively greater width and depth and treated with additional acid-etching was much effective in improving expressions of genes involved in cell-substratum adhesion and cell proliferation, which was consistent with the results of cell proliferation analysis.

The present inventors proved with the results of Experimental Examples 1, 2 and 3 that the titanium implant with microgrooves having comparatively greater width, bottom width and depth and treated with additional acid-etching was much effective in improving expressions of genes involved in cell-substratum adhesion and cell proliferation of human gingival fibroblasts.

TABLE 31

Target genes and primers

| Target | Forward primer | Reverse primer | |
|---|---|---|---|
| gene* | (SEQ. ID. NO) | (SEQ. ID. NO) | Size |
| FN | CGAACATCCACACGGTA | ATCACATCCACACGGTAG | 639 bp |
| | G (1) | (2) | |
| a5 | ACCAAGGCCCCAGCTCC | GCCTCACACTGCAGGCTAAA | 376 bp |
| integrin | ATTAG (3) | TG (4) | |
| EGFR | AGTGGTCCTTGCAAACT | GTTGACATCCATCTGGTACG | 664 bp |
| | TGG (5) | (6) | |
| TGF-BR-I | ATTGCTGGACCAGTG | TAAGTCTGCAATACAGCAA | 668 bp |
| | TGCTTCGTCGTC (7) | GTTCCATTCTT (8) | |
| TGF-BR- | CGCTTTGCTGAGGT | GATATTGGAGCTCT | 395 bp |
| II | CTATAAGGCC (9) | TGAGGTCCCT (10) | |
| FGFR | ATCATCTATTGC | CATACTCAGAGACC | 259 bp |
| | ACAGGGGCC (11) | CCTGCTAGC (12) | |
| RhoA | CTGGTGATTGTT | GCGATCATAATCT | 183 bp |
| | GGTGATGG (13) | TCCTGCC (14) | |
| Rac1 | ATGCAGGCCATCAA | TTACAACAGCAGGCA | 636 bp |
| | GTGTGTGGTG (15) | TTTTCTCTTCC (16) | |
| Cdc42 | TTCTTGCTTGTT | CAGCCAATATTG | 199 bp |
| | GGGACTCA (17) | CTTCGTCA (18) | |
| Rho | GAAGAAAGAGAAGC | ATCTTGTAGCTCC | 369 bp |
| kinase-1 | TCGAGAGAAGG (19) | CGCATCTGT (20) | |
| Akt-1 | ATGAGCGACGTGG | GAGGCCGTCAGCCAC | 330 bp |
| | CTATTGTGAAG (21) | AGTCTGGATG (22) | |
| PKC | ATGGCTGACGT | GCAGAGGCTGG | 453 bp |
| | TTTCCCGG (23) | GGACATTG (24) | |
| KGF1 | CTGACATGGT | GAGAAGCTTCCAACTG | 304 bp |
| | CCTGCCAAC (25) | CCACTGTCCTG (26) | |
| MEK1 | GGAGGCCTTG | CTTTCTTCAGG | 383 bp |
| | CAGAAGAAG (27) | ACTTGATCC (28) | |
| Erk2 | TCTGTAGGCT | GGCTGGAATC | 431 bp |
| | GCATTCTGGC (29) | TAGCAGTC (30) | |
| cMyc | GAACAAGAAGATGAG | CCCAAAGTCCAAT | 718 bp |
| | GAAGAAATCGATG (31) | TTGAGGCAG (32) | |
| Cyclin | ATTAGTTTAC | GATGGAGCCGTCGG | 399 bp |
| D1 | CTGGACCCAG (33) | TGTAGATGCA (34) | |
| Cyclin E | CAGCCTTGGGAC | TGCAGAAGAGG | 254 bp |
| | AATAATGC (35) | GTGTTGCTC (36) | |
| CDK2 | ACGTACGGAGTT | GCTAGTCCAAAGTC | 405 bp |
| | GTGTACAAAGCC (37) | TGCTAGCTTG (38) | |
| CDK4 | CCAAAGTCAGCCA | CATGTAGACCAGGAC | 193 bp |
| | GCTTGACTGTT (39) | CTAAGGACA (40) | |
| CDK6 | TGATGTGTGCACAG | CTGTATTCAGCTC | 737 bp |
| | TGTCACGAAC (41) | CGAGGTGTTCT (42) | |
| p21cip1 | AGTGGACAGCGA | TAGAAATCTCTCA | 380 bp |
| | GCAGCTGA (43) | TGCTGGTCTG (44) | |
| p27kip1 | AAACGTGCGAGTG | CGCTTCCTTATTC | 454 bp |
| | TCTAACGGGA (45) | CTGCGCATTG (46) | |
| B-actin | ATCGTGGGCCGC | TTGCCCTTAGGGT | 345 bp |
| | CCTAGGCA (47) | TTCAGAGGGG (48) | |

*FN: fibronectin,
a5 integrin: alpha 5 integrin,
EGER: epidermal growth factor receptor,
TGF-BR-I: transforming growth factor Breceptor type 1,
TGF-BR-II: transforming growth factor Breceptor type 2,
FGFR: fibroblast growth factor receptor,
RhoA: Ran homologue gene group, member A,
Rac1: Ras-related C3 botulinum toxin substrate 1,
Cdc42: cell division cycle 42,
Rho kinase-1: Rho kinase-l,
Akt-1: V-akt murine thymoma viral oncogene homolog 1,
PKC: protein kinase C,
KGF1: keratinocyte growth factor 1,
MEK1: meiosis-specific serine/threonine protein kinase 1,
Erk2: extracellular signal-regulated kinase 2,
cMyc: V-myc myelocytomatosis viral oncogene homolog,
Cyclin D1: cyclin D1,
Cyclin E: cyclin E,
CDK2: cyclin-dependent kinase 2,
CDK4: cyclin-dependent kinase 4,
CDK6: cyclin-dependent kinase 6,
B-actin: beta-actin

### INDUSTRIAL APPLICABILITY

The dental implant or implant abutment of the present invention is surface-treated. Particularly, microgrooves in the shape of well having greater width and bottom width than the section diameter of a human fibroblast are formed on the surface of the implant to induce attachment of gingival soft tissue. Then, cell behavior including cell-substratum adhesion, cell proliferation and expressions of genes involved in those actions of human gingival fibroblasts can be increased by the microgroove formation on the implant. The implant of the present invention can overcome the problems of the conventional implant such as short life-time, therefore, the implant of the present invention can be effectively used in various industrial fields.

The present invention can increase attachment between the implant and soft tissue by inducing more active generation of filopodia by treating additional acid-etching on the entire surface of the implant including microgrooves and ridges. The titanium substratum and dental implant for cell culture which have microgrooves formed on their surfaces and at the same time treated with acid-etching have not been reported, so far, and first developed by the present inventors. According to the present invention, stability of the implant is increased and life-time of the implant is extended by improving the attachment of implant-surrounding tissues, so that aftereffects after the implant installation is significantly reduced and the surrounding tissues can be healthier.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A dental implant or implant abutment having microgrooves in the shape of well on adherent region of the implant surface, which is composed of an abutment region in the upper part where an artificial tooth is fixed and a dental implant region in the lower part which is installed on jawbone.

2. The dental implant or implant abutment according to claim 1, wherein the microgrooves have greater width and bottom width than the section diameter of a human gingival fibroblast.

3. The dental implant or implant abutment according to claim 1, wherein the microgrooves have the section in the shape of a rectangle or a trapezoid.

4. The dental implant or implant abutment according to any of claim 1-claim 3, wherein the surfaces of microgrooves and ridges were treated with acid-etching.

5. A method for treating surface of the dental implant using photolithography comprising the following steps:
i) treating photo-resist onto the surface of abutment of a dental implant except the region reserved for forming grooves;
ii) performing acid-etching on the dental implant or implant abutment treated with the photo-resist in step 1); and
iii) eliminating the photo-resist from the dental implant or implant abutment finished with acid-etching.

6. The method for treating surface of the dental implant or implant abutment according to claim 5, wherein the section of the groove is in the shape of a rectangle or a trapezoid.

7. The method for treating surface of the dental implant or implant abutment according to claim 5, wherein the groove has greater width and bottom width than the section diameter of a human gingival fibroblast.

8. The method for treating surface of the dental implant or implant abutment according to any of claim 5-7, wherein the acid-etching is additionally performed on the surface of the dental implant or implant abutment without the photo-resist.


SEQUENCE LISTING (48 sequences)

SEQ ID NO: 1 - DNA, 18 bp, Artificial Sequence
  FN-forward primer
cgaacatccacacggtag

SEQ ID NO: 2 - DNA, 18 bp, Artificial Sequence
  FN-reverse primer
atcacatccacacggtag

SEQ ID NO: 3 - DNA, 22 bp, Artificial Sequence
  alpha5 integrin forward primer
accaaggccccagctccattag

SEQ ID NO: 4 - DNA, 22 bp, Artificial Sequence
  alpha5 integrin reverse primer
gcctcacactgcaggctaaatg

SEQ ID NO: 5 - DNA, 20 bp, Artificial Sequence
  EGFR forward primer
agtggtccttggaaacttgg

SEQ ID NO: 6 - DNA, 20 bp, Artificial Sequence
  EGFR reverse primer
gttgacatccatctggtacg

SEQ ID NO: 7 - DNA, 27 bp, Artificial Sequence
  TGF beta R-I forward primer
attgctggaccagtgtgcttcgtcgtc

SEQ ID NO: 8 - DNA, 30 bp, Artificial Sequence
  TGF beta R-I reverse primer
taagtctgcaatacagcaagttccattctt

SEQ ID NO: 9 - DNA, 24 bp, Artificial Sequence
  TGF beta R-II forward primer
cgctttgctgaggtctataaggcc

SEQ ID NO: 10 - DNA, 24 bp, Artificial Sequence
  TGF beta R-II reverse primer
gatattggagctcttgaggtccct

SEQ ID NO: 11 - DNA, 21 bp, Artificial Sequence
  FGFR forward primer
atcatctattgcacaggggcc

SEQ ID NO: 12 - DNA, 23 bp, Artificial Sequence
  FGFR reverse primer
catactcagagacccctgctagc

SEQ ID NO: 13 - DNA, 20 bp, Artificial Sequence
  RhoA forward primer
ctggtgattgttggtgatgg

SEQ ID NO: 14 - DNA, 20 bp, Artificial Sequence
  RhoA reverse primer
gcgatcataatcttcctgcc

SEQ ID NO: 15 - DNA, 24 bp, Artificial Sequence
  Rac1 forward primer
atgcaggccatcaagtgtgtggtg

SEQ ID NO: 16 - DNA, 26 bp, Artificial Sequence
  Rac1 reverse primer
ttacaacagcaggcattttctcttcc

SEQ ID NO: 17 - DNA, 20 bp, Artificial Sequence
  cdc42 forward primer
ttcttgcttgttgggactca

SEQ ID NO: 18 - DNA, 20 bp, Artificial Sequence
  cdc42 reverse primer
cagccaatattgcttcgtca

SEQ ID NO: 19 - DNA, 25 bp, Artificial Sequence
  Rho kinase-1 forward primer
gaagaaagagaagctcgagagaagg

SEQ ID NO: 20 - DNA, 22 bp, Artificial Sequence
  Rho kinase-1 reverse primer
atcttgtagctcccgcatctgt

SEQ ID NO: 21 - DNA, 24 bp, Artificial Sequence
  Akt-1 forward primer
atgagcgacgtggctattgtgaag

SEQ ID NO: 22 - DNA, 25 bp, Artificial Sequence
  Akt-1 reverse primer
gaggccgtcagccacagtctggatg

SEQ ID NO: 23 - DNA, 19 bp, Artificial Sequence
  PKC forward primer
atggctgacgttttcccgg

SEQ ID NO: 24 - DNA, 19 bp, Artificial Sequence
  PKC reverse primer
gcagaggctggggacattg

SEQ ID NO: 25 - DNA, 19 bp, Artificial Sequence
  KGF1 forward primer
ctgacatggtcctgccaac

SEQ ID NO: 26 - DNA, 27 bp, Artificial Sequence
  KGF1 reverse primer
gagaagcttccaactgccactgtcctg

SEQ ID NO: 27 - DNA, 19 bp, Artificial Sequence
  MEK1 forward primer
ggaggccttgcagaagaag

SEQ ID NO: 28 - DNA, 20 bp, Artificial Sequence
  MEK1 reverse primer
ctttcttcaggacttgatcc

SEQ ID NO: 29 - DNA, 20 bp, Artificial Sequence
  Erk2 forward primer
tctgtaggctgcattctggc

SEQ ID NO: 30 - DNA, 18 bp, Artificial Sequence
  Erk2 reverse primer
ggctggaatctagcagtc

SEQ ID NO: 31 - DNA, 28 bp, Artificial Sequence
  cMyc forward primer
gaacaagaagatgaggaagaaatcgatg

SEQ ID NO: 32 - DNA, 22 bp, Artificial Sequence
  cMyc reverse primer
cccaaagtccaatttgaggcag

SEQ ID NO: 33 - DNA, 20 bp, Artificial Sequence
  cyclin D1 forward primer
attagtttacctggacccag

SEQ ID NO: 34 - DNA, 24 bp, Artificial Sequence
  cyclin D1 reverse primer
gatggagccgtcggtgtagatgca

SEQ ID NO: 35 - DNA, 20 bp, Artificial Sequence
  cyclin E forward primer
cagccttgggacaataatgc

SEQ ID NO: 36 - DNA, 20 bp, Artificial Sequence
  cyclin E reverse primer
tgcagaagagggtgttgctc

SEQ ID NO: 37 - DNA, 24 bp, Artificial Sequence
  CDK2 forward primer
acgtacggagttgtgtacaaagcc

SEQ ID NO: 38 - DNA, 24 bp, Artificial Sequence
  CDK2 reverse primer
gctagtccaaagtctgctagcttg

SEQ ID NO: 39 - DNA, 24 bp, Artificial Sequence
  CDK4 forward primer
ccaaagtcagccagcttgactgtt

SEQ ID NO: 40 - DNA, 24 bp, Artificial Sequence
  CDK4 reverse primer
catgtagaccaggacctaaggaca

SEQ ID NO: 41 - DNA, 24 bp, Artificial Sequence
  CDK6 forward primer
tgatgtgtgcacagtgtcacgaac

SEQ ID NO: 42 - DNA, 24 bp, Artificial Sequence
  CDK6 reverse primer
ctgtattcagctccgaggtgttct

SEQ ID NO: 43 - DNA, 20 bp, Artificial Sequence
  p21 forward primer
agtggacagcgagcagctga

SEQ ID NO: 44 - DNA, 23 bp, Artificial Sequence
  p21 reverse primer
tagaaatctgtcatgctggtctg

SEQ ID NO: 45 - DNA, 23 bp, Artificial Sequence
  p27 forward primer
aaacgtgcgagtgtctaacggga

SEQ ID NO: 46 - DNA, 23 bp, Artificial Sequence
  p27 reverse primer
cgcttccttattcctgcgcattg

SEQ ID NO: 47 - DNA, 20 bp, Artificial Sequence
  beta-actin forward primer
atcgtgggccgccctaggca

SEQ ID NO: 48 - DNA, 21 bp, Artificial Sequence
  beta-actin reverse primer
tggccttagggttcagagggg